(19) United States
(12) Patent Application Publication
(10) Pub. No.: US 2012/0144379 A1
(43) Pub. Date: Jun. 7, 2012

(54) SYSTEM AND METHOD FOR UPDADTING SOFTWARE

(75) Inventor: Teng-Yu TSAI, Tu-Cheng (TW)

(73) Assignee: HON HAI PRECISION INDUSTRY CO., LTD., Tu-Cheng (TW)

(21) Appl. No.: 13/205,695

(22) Filed: Aug. 9, 2011

(30) Foreign Application Priority Data
Dec. 7, 2010 (TW) 99142702

(51) Int. Cl. G06F 9/44

(52) U.S. Cl. 717/170

(57) ABSTRACT

A system for updating software in a computer is disclosed. The system collects the current version information of a plurality of software applications that are installed in the computing device and obtains the latest version information of the plurality of software applications from a software management server. The system generates an update list, which includes update information of one or more software applications that are determined to be updated according to the current version information and the latest version information. Then the system downloads updates according to the update list and applies the updates to the corresponding software applications in the computer.

### BACKGROUND

1. Technical Field

The disclosure generally relates to a system and a method for updating software in a computing device.

2. Description of Related Art

It is often necessary to update a software application to fix bugs, improve performance or add new functions. A user or an administrator of a software application may find and download an update file, also referred to as a patch file, from the official website of the software application or a software download portal site. Then the user or the administrator can apply updates to the software application by executing the downloaded update file. The other way to update a software application is to open the software application and use its own update function to perform an update process. However many software applications don't have an update function. Even though the software application does have the update function, it still needs the user to launch the update function manually. Both of the two ways are not convenient enough to the user, especially when the amount of the software applications which need to be updated is extremely huge.

Therefore, there is room for improvement in software updating method.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of a computing device suitable for use in implementing a software updating system.

FIG. 2 is a schematic diagram of one embodiment of the function modules of the software system of FIG. 1.

FIG. 3 is a view of a graphic user interface for notifying a user that one or more updates are available in one embodiment.

FIG. 4 is a view of a graphic user interface for selecting software applications to be updated according to one embodiment.

FIG. 5 is a view of a graphic user interface for reporting the update results to a user according to one embodiment.

FIG. 6 is an operational flow diagram representing an exemplary embodiment of a method for updating software in a computer device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

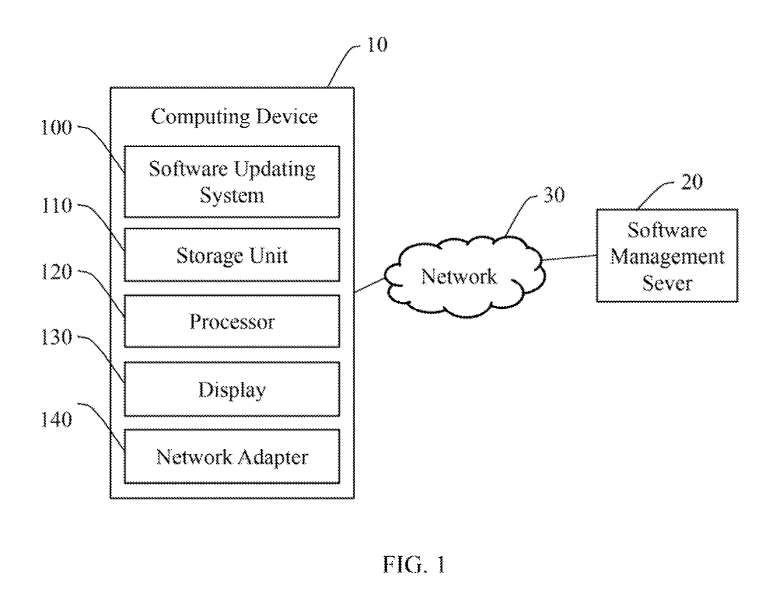

FIG. 1 shows a schematic diagram of one embodiment of a computing device 10 comprising a software updating system 100, a storage unit 110, at least one processor 120, a display 130, and a network adapter 140. The computing device 10 implements the functions of the software updating system 100. The computing device 10 is a general purpose computing device such as a desktop computer, a laptop computer, a tablet PC or a smart phone. The storage unit 110 may be a magnetic or an optical storage device, such as a hard disk drive, an optical drive, or a tape drive. The display 130 may be a liquid crystal display (LCD) or a cathode-ray tube (CRT) display.

With reference to FIG. 1, the computing device 10 may operate in a network 30 which provides logical connections to one or more remote computers, such as a software management server 20. The network 30 may be a local area network (LAN) or a wide area network (WAN), such as the Internet. The computing device 10 is connected to the network 30 through the network adapter 140. The network adapter 140 may be a network interface card using a specific physical layer and a data link layer standard such as Ethernet or Wi-Fi.

At least one operating system (OS) is installed in the computing device 10, which manages computer hardware resources and provides common services for execution of various software applications. A user can install one or more software applications in the operating system. Each software application installed in the computing device 10 has corresponding version information (current version information), which may include a version number (current version number) to identify a unique version of the software application. In one embodiment, the greater the version number is, the newer the version of a software application is.

The software management server 20 may provide the latest version information of a plurality of software applications, which may be maintained by a software developer or a computer vender. The latest version information may include a version number (latest version number) for each of the plurality of software applications. The latest version information may also include a plurality of uniform resource locators (URLs) to specify where a plurality of update files for the latest version of the plurality of software applications is. For example, a URL “http://gl.op.cc/update2to3.msi” may specify an update file named “update2to3.msi” located in a HTTP server whose domain name is “gl.op.cc” in the HTTP protocol. In one embodiment, the software management server 20 may store a plurality of update files for the latest version of the plurality of software applications in its own storage and may provide the update files to multiple client computers such as the computing device 10.

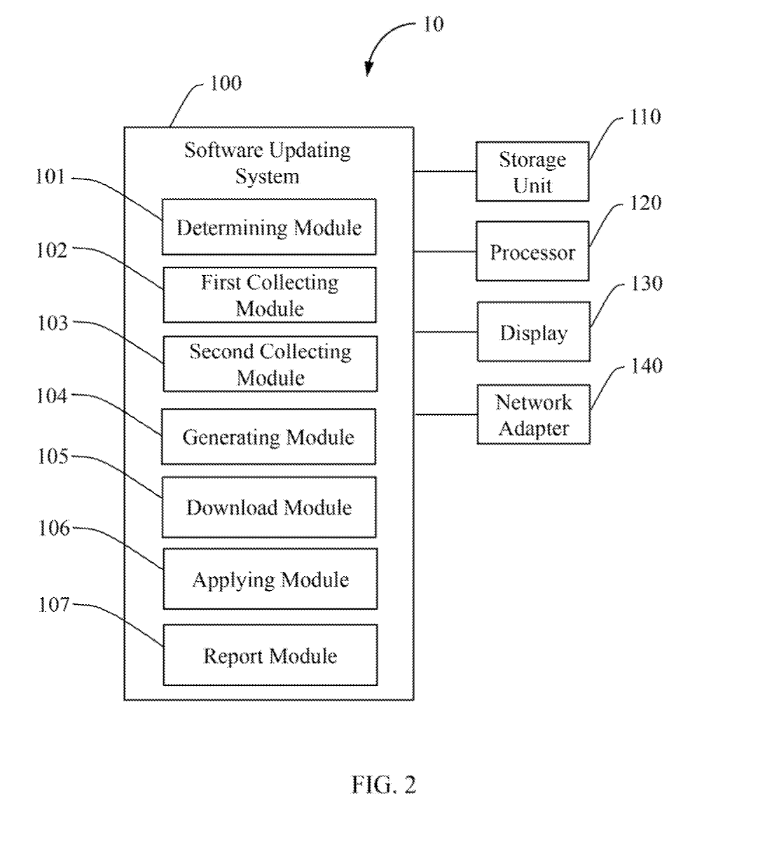

FIG. 2 is a schematic diagram of one embodiment of the function modules of the software updating system 100. In the embodiment, the software updating system 100 includes a determining module 101, a first collecting module 102, a second collecting module 103, a generating module 104, a download module 105, an applying module 106, and a report module 107.

The determining module 101 may determine whether a predetermined event occurs. If the predetermined event is detected, the update function of the software updating system 100 can be initiated. Otherwise the update function of the software updating system 100 remains in hibernation. The predetermined event, for example, may be a timer that triggers every a time period such as a week. The predetermined event may also be detection of a user operation in a user interface which is displayed in the display 130. The information of the predetermined event can be stored in the storage unit 110.

The first collecting module 102 may collect current version information of a plurality of software applications that are installed in the computing device 10. The current version information may include a current version number of each of the plurality of software applications. The generating module 104 generates an update list and adds the update information of one or more particular software applications to the update list according to selection(s) of the user in the user interface.

The second collecting module 103 may obtain the latest version information of the plurality of software applications from the software management server 20. The latest version information may include the version number of each of the latest version of the plurality of software applications. In one embodiment, the latest version information may include a plurality of URLs to specify where a plurality of update files for the latest version of the plurality of software applications is.

The generating module 104 may compare the current version information of each of the plurality of software applications to the corresponding latest version information. If the current version number of a software application is smaller than the corresponding latest version number of the software application, the generating module 104 can combine the current version information and the corresponding latest version information as update information for the software application. If the current version number of a software application is larger than or equal to the corresponding latest version number of the software application, it means there is no available update for that software application.

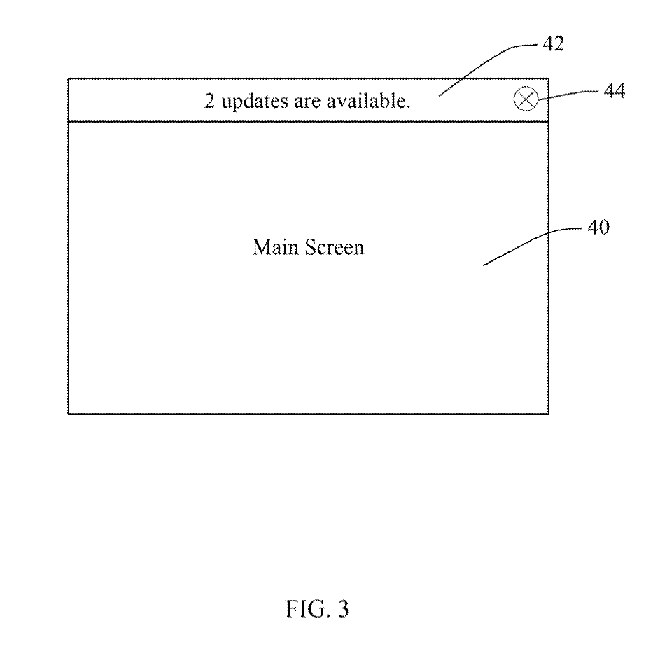

When there is at least one available update, the generating module 104 may send a message to the user. FIG. 3 illustrates an embodiment of a graphic user interface (GUI) for displaying a message in a notification bar 42 on the main screen 40 for notifying the user that 2 updates are available. The user can enter the other GUI for selecting one or more particular software applications to be updated by clicking at any position of the notification bar 42 other than an exit button 44. If the user clicks the exit button 44, the notification bar 42 will be closed and that message will be ignored by the user accordingly.

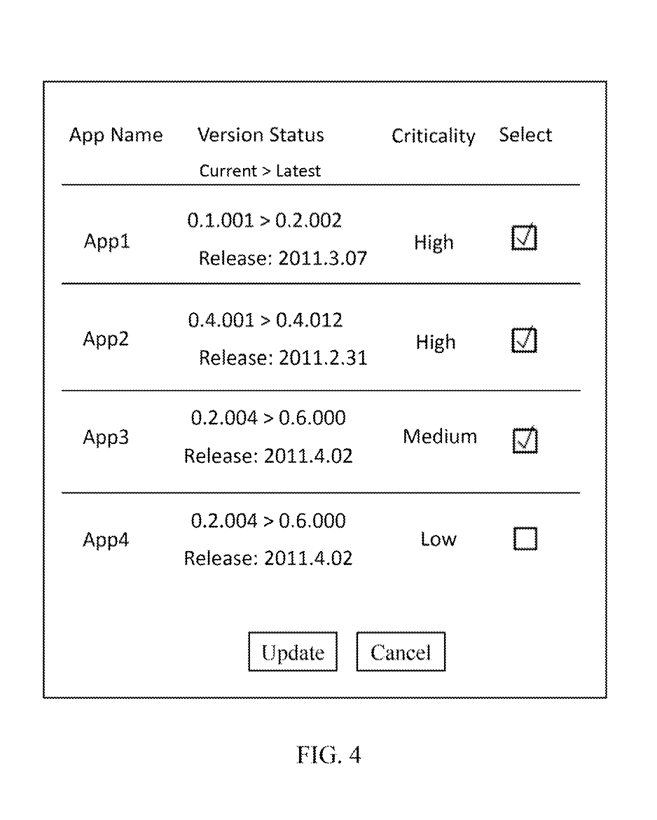

FIG. 4 shows a GUI for the user to select the software applications that need to be updated. The generating module 104 displays the update information of the software applications that have available updates in the GUI depicted by FIG. 4. The generating module 104 may sort the update information according to the criticality of each of these software applications which are listed in the GUI. For example, the criticality of a software application may be high, medium, or low. When the user selects one or more software applications by clicking the corresponding check boxes in the GUI, the generating module 104 can generate an update list and add the update information of the selected software applications to the update list. The update list may include a plurality of URLs to specify where a plurality of update files for the selected software applications is.

When the user selects one or more software applications and clicks the update button in the GUI of FIG. 4, the download module 105 can download one or more update files according to the plurality of URLs in the update list. In other embodiments, the software management server 20 stores the one or more update files. The download module 105 can download the one or more update files from the software management server 20.

The applying module 106 may execute or deploy the downloaded one or more update files to apply updates to the one or more corresponding software applications.

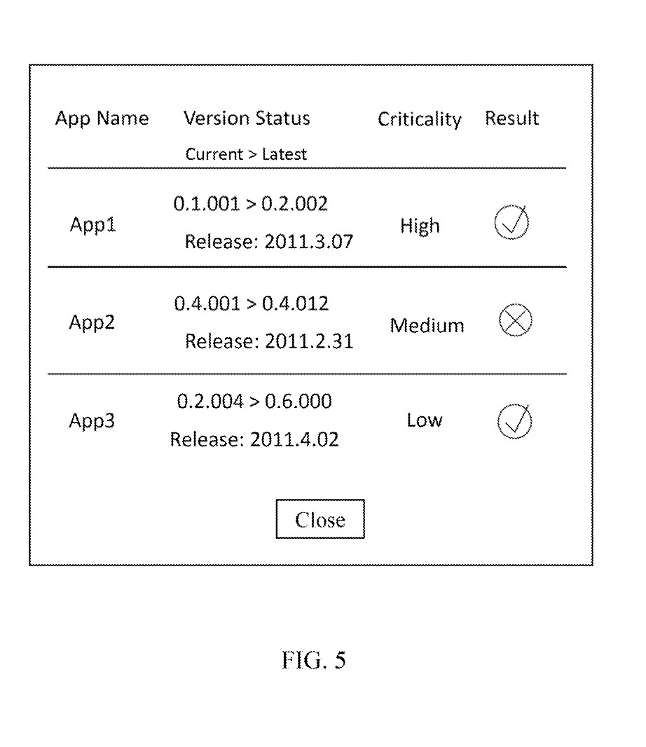

The report module 107 may display result information on the display 130 to notify whether the updates have been applied to the one or more corresponding software applications successfully. With reference with FIG. 5, a result report is shown to the user in a GUI. In the report, the user can find out whether a software application has been updated to the latest version successfully or not.

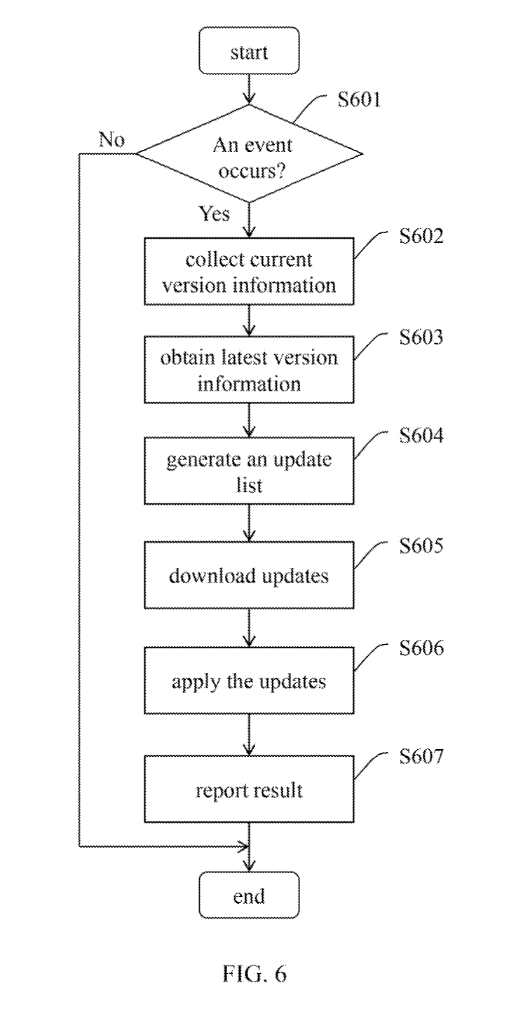

FIG. 6 is a flowchart illustrating one embodiment of a method for updating software in a computer device. The method may include the following steps.

In step S601, the determining module 101 determines whether a predetermined event occurs. If the predetermined event is detected, the flow goes to step S602, otherwise the flow ends. The predetermined event, for example, may be a timer that triggers every a time period such as a week. The predetermined event may also be detection of a user operation in a user interface, which is displayed in the display 130.

In step S602, the first collecting module 102 collects the current version information of a plurality of software applications that are installed in the computing device 10. The current version information may include the current version number of each of the plurality of software applications.

In step S603, the second collecting module 103 obtains the latest version information of the plurality of software applications from the software management server 20. The latest version information may include the version number of each of the latest version of the plurality of software applications.

In step S604, the generating module 104 compares the current version information of each of the plurality of software applications to the corresponding latest version information. If the current version number of a software application is smaller than the corresponding latest version number of the software application, the generating module 104 can combine the current version information and the corresponding latest version information as update information for the software application.

In step S605, the download module 105 downloads one or more update files according to the update list.

In step S606, the applying module 106 applies the one or more updates to the one or more corresponding software applications.

In step S606, the report module 107 displays result information on the display 130 to notify whether the updates have been applied to the one or more corresponding software applications successfully.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A computer-implemented method for updating software in a computing device, wherein the computing device is in electronic communication with a server on a network, the method comprising:
detecting a predetermined event;
collecting current version information of a plurality of software applications that are installed in the computing device;
obtaining latest version information of the plurality of software applications from the server;
generating an update list, wherein the update list comprises update information of one or more software applications that are determined to be updated according to the current version information and the latest version information;
downloading one or more updates according to the update list; and
applying the one or more updates to one or more corresponding software applications of the plurality of software applications.

2. The method of claim 1, wherein the current version information comprises current version numbers of the plurality of software applications, and the latest version information comprises latest version numbers of the plurality of software applications.

3. The method of claim 2, wherein the generating the update list further comprises:
comparing a current version number of each of the plurality of software applications to a corresponding latest version number; and
determining update information of one of the plurality of software applications when the current version number of the one of the plurality of software applications is smaller than the latest version number of the one of the plurality of software applications.

4. The method of claim 1, wherein the generating the update list further comprises displaying the update information in a user interface on a display of the computing device.

5. The method of claim 4, wherein the displaying the update information on the display further comprises sorting the update information according to criticality of the one or more software applications.

6. The method of claim 4, wherein the generating the update list further comprises adding the update information of one or more particular software applications to the update list according to selection(s) of a user in the user interface.

7. The method of claim 1, further comprising displaying result information on the display to notify whether the one or more updates have been applied to the one or more corresponding software applications successfully.

8. The method of claim 1, wherein the predetermined event comprises a timer that triggers every a time period.

9. The method of claim 1, wherein the predetermined event comprises detection of a user operation in a user interface.

10. The method of claim 1, wherein the update information comprises one or more uniform resource locators (URLs) that specify where the one or more updates are.

11. A system for updating software in a computing device, wherein the computing device is in electronic communication with a server on a network, the system comprising:
a determining module adapted to detect a predetermined event;
a first collecting module adapted to collect current version information of a plurality of software applications that are installed in the computing device;
a second collecting module adapted to obtain latest version information of the plurality of software applications from the server;
a generating module adapted to generate an update list, wherein the update list comprises update information of one or more software applications that are determined to be updated according to the current version information and the latest version information;
a download module adapted to download one or more updates according to the update list; and
an applying module adapted to apply the one or more updates to one or more corresponding software applications of the plurality of software applications.

12. The system of claim 11, wherein the current version information comprises current version numbers of the plurality of software applications, and the latest version information comprises latest version numbers of the plurality of software applications.

13. The system of claim 12, wherein the generating module is further adapted to compare current version number of each of the plurality of software applications to a corresponding latest version number; and determine update information of one of the plurality of software applications when the current version number of the one of the plurality of software applications is smaller than the latest version number of the one of the plurality of software applications.

14. The system of claim 11, wherein the generating module is further adapted to display the update information in a user interface on a display of the computing device.

15. The system of claim 14, wherein the generating module is further adapted to sort the update information according to criticality of the one or more software applications.

16. The system of claim 14, wherein the generating module is further adapted to add the update information of one or more particular software applications to the update list according to selection(s) of a user in the user interface.

17. The system of claim 11, further comprising a report module adapted to display result information on the display to notify whether the one or more updates have been applied to the one or more corresponding software applications successfully.

18. The system of claim 11, wherein the predetermined event comprises a timer that triggers every a time period.

19. The system of claim 11, wherein the update information comprises one or more uniform resource locators (URLs) that specify the one or more updates are.

20. A computer-implemented method for updating software in a computing device, wherein the computing device is in electronic communication with a server on a network, the method comprising:
providing a determining module, a first collecting module, a second collecting module, a generating module, a download module, and an applying module;
detecting a predetermined event by the determining module;
collecting a current version information of a plurality of software applications that are installed in the computing device by the first collecting module;
obtaining latest version information of the plurality of software applications from the server by the second collecting module;
generating an update list by the generating module, wherein the update list comprises update information of one or more software applications that are determined to be updated according to the current version information and the latest version information;
downloading one or more updates according to the update list by the download module; and
applying the one or more updates to one or more corresponding software applications of the plurality of software applications by the applying module.
